(19) United States
(12) Patent Application Publication
(10) Pub. No.: US 2016/0212249 A1
(43) Pub. Date: Jul. 21, 2016

(54) HOUSING AND METHOD FOR MANUFACTURING THE SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: NAI-LIN YANG, New Taipei (TW); WEN-BIN SUN, Shenzhen (CN); HONG-YU JIANG, Shenzhen (CN); BING ZHANG, Shenzhen (CN)

(21) Appl. No.: 14/928,255

(22) Filed: Oct. 30, 2015

(30) Foreign Application Priority Data
Jan. 16, 2015 (CN) 201510021380.1

(51) Int. Cl. H04M 1/02

(52) U.S. Cl. CPC H04M 1/0249

(57) ABSTRACT

A housing includes a composite panel, a printing layer, and an injection layer. The composite panel includes a base layer, a cementing layer, and a film. The film is integrally glued on the base layer by the cementing layer, the printing layer is disposed on the base layer opposite to the film, and the injection layer is disposed to the printing layer. The present disclosure further relates to a method for making the housing.

### CROSS-REFERENCE TO RELATED APPLICATIONS

This application claims priority to Chinese Patent Application No. 201510021380.1 filed on Jan. 16, 2015, the contents of which are incorporated by reference herein.

### FIELD

The subject matter herein generally relates to a housing, and particularly relates to a housing formed by composite panels and a method for manufacturing the housing.

### BACKGROUND

Personal digital assistants (PDAs), laptop computers, mobile phones, personal computers, and other electronic devices have become an indispensable part in our life and work. Most consumers not only have the functional requirement of the electronic devices, but also have more high requirement for its appearance.

### BRIEF DESCRIPTION OF THE DRAWING

Implementations of the present technology will now be described, by way of example only, with reference to the attached figure.

FIG. 1 is an assembled, isometric view of a housing, according to an exemplary embodiment.

FIG. 2 is a cross-sectional view taken along line II-II of FIG. 1.

FIG. 3 illustrates the housing in a series of states during the manufacturing the housing of FIG. 1.

FIG. 4 illustrates a method for manufacturing the housing of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. The term “comprising” when utilized, means “including, but not necessarily limited to”; it specifically indicates open-ended inclusion or membership in the so-described combination, group, series and the like.

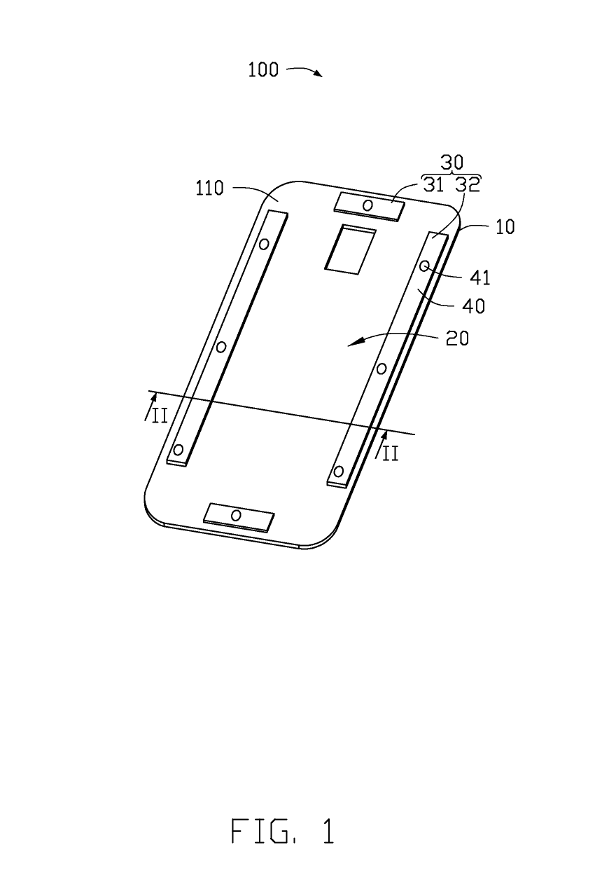

FIG. 1 illustrates an assembled, isometric view of a housing 100 mounted to an electronic device, according to an exemplary embodiment. In at least one embodiment, the electronic device is a mobile phone. The housing 100 includes a composite panel 10, a printing layer 20, a connecting layer 30, and an injection layer 40. In at least one embodiment, the housing 100 is substantially a rectangular-shaped plate, two opposite sides of the housing 100 are bent toward a center of the housing 100 and thus form two bent portions 110. The printing layer 20 is printed on an inner surface of the composite panel 10, the connecting layer 30 is printed on the printing layer 20, and the injection layer 40 is molded onto the connecting layer 30.

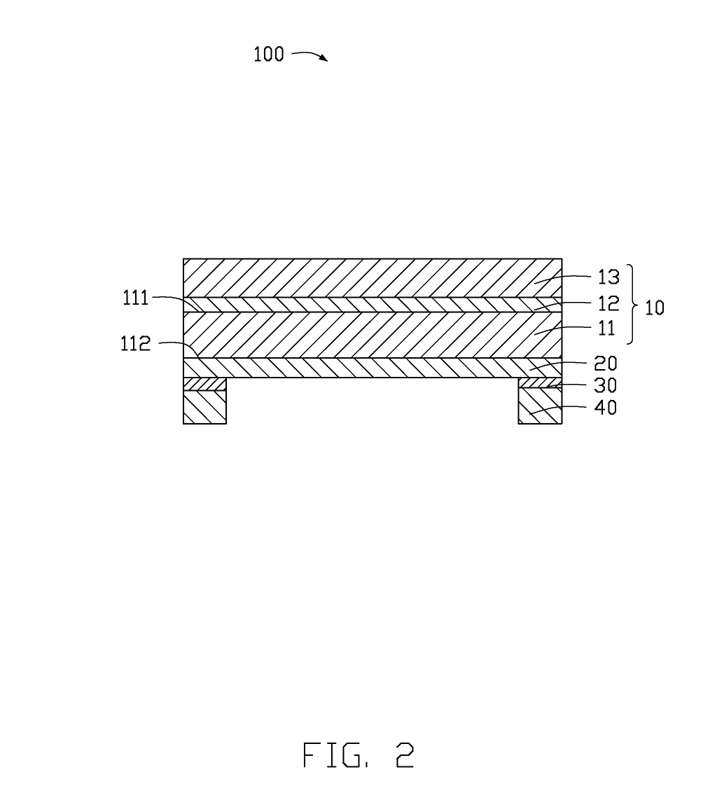

FIG. 2 illustrates the composite panel 10 includes a base layer 11, a cementing layer 12, and a film 13. The base layer 11 includes a first surface 111 and a second surface 112 opposite to the first surface 111. The base layer 11 is made of transparent or translucent materials, such as Polyethylene Terephthalate(PET), Polycarbonate (PC), or Polymethyl Methacrylate (PMMA). The cementing layer 12 is disposed to the first surface 111 and is used for adhering the base layer 11 to the film 13. The cementing layer 12 can be a double-sided adhesive, such as an Optically Clear Adhesive (OCA) or a Polyurethane Resin (PUR). In other exemplary embodiments, the cementing layer 12 can be selected from other adhesives according to materials of the base layer 11 and the film 13. The film 13 is disposed on a side of the base layer 11 by the cementing layer 12 to serve as an appearance surface of the housing 100, in at least one embodiment, the film 13 is a high hardness film, such us a glass film or a PET film.

The printing layer 20 is printed on the second surface 112 by the In-Mold-Label (IML) process, the printing layer 20 can be inks and can have colors and/or patterns.

The connecting layer 30 is disposed on the printing layer 20 by printing, painting, gluing, or other processes. In at least one embodiment, the connecting layer 30 includes two first gluing portion 31 and two second gluing portion 32. The two first gluing portion 31 are located at two opposite ends of the housing 100, and the two second gluing portion 32 are located at two opposite sides of the housing 100.

The injection layer 40 is disposed on the connecting layer 30 by an injection molding process. In at least one embodiment, the injection layer 40 includes a positioning portion 41 used for latching a positioning groove (not shown) of the mobile phone, and thus the housing 100 can be mounted on the mobile phone. The connecting layer 30 used to firmly combine injection layer 40 with printing layer 20. In this exemplary embodiment, a thickness of the housing 100 can be about 0.4 mm-0.7 mm.

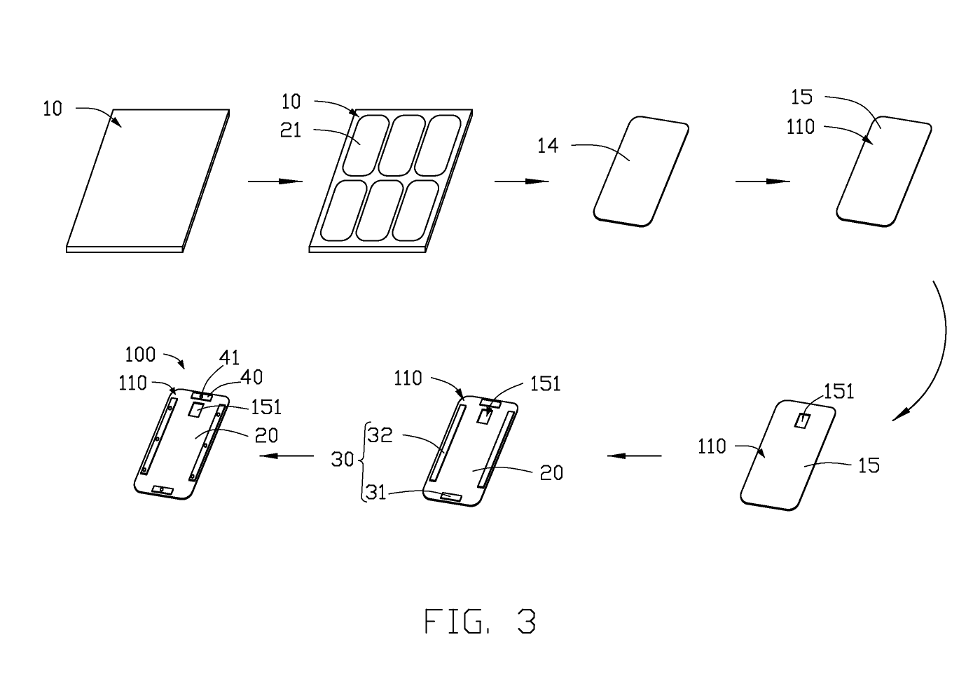

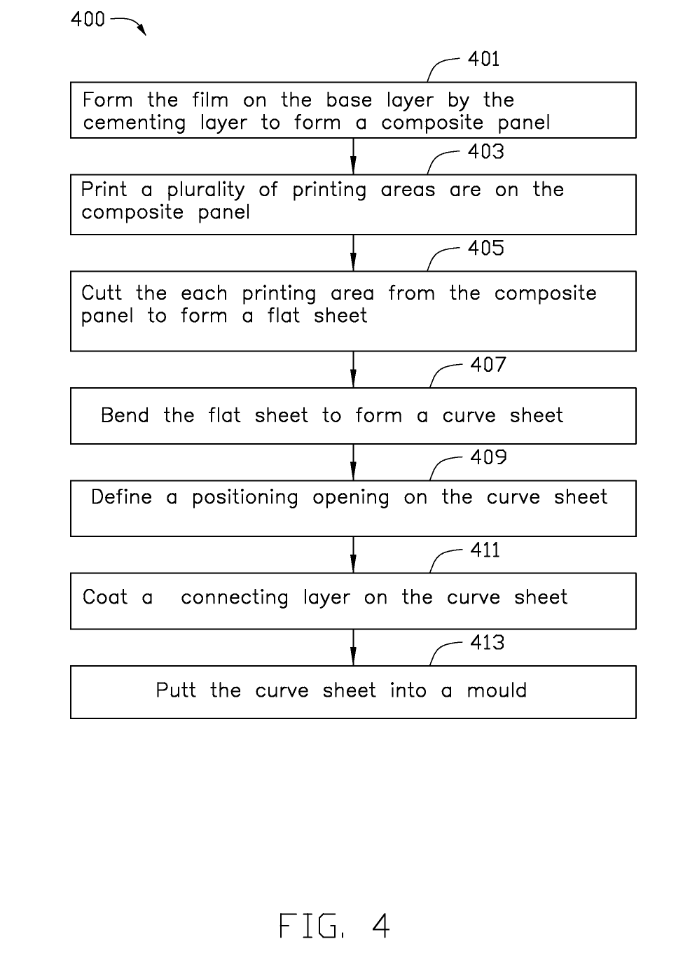

Referring to FIGS. 3 and 4, a flowchart is presented in accordance with an example embodiment. The method 400 is provided by way of example, as there are a variety of ways to carry out the method. The method 400 described below can be carried out using the configurations illustrated in FIGS. 1-3, for example, and various elements of these figures are referenced in explaining method 400. Each block shown in FIG. 4 represents one or more processes, methods or subroutines, carried out in the example method 400. Furthermore, the order of blocks is illustrative only and the order of the blocks can change according to the present disclosure. Additional blocks can be added or fewer blocks can be utilized, without departing from this disclosure. The method 400 for making the housing 10 can begin at block 401.

At block 401, the film 13 is integrally glued on the base layer 11 by the cementing layer 12 to form the composite panel 10.

At block 403, the printing layer 20 is printed on the second surface 112 of the base layer 11 according to the shape of the housing 100, in at least one embodiment, the printing layer 20 includes a plurality of printing areas 21 arranged on the composite panel 10, a shape of each printing area 21 corresponds to the shape of the housing 100.

At block 405, the printing area 21 is cut from the composite panel 10 by a cutting equipment to form a plurality of flat sheets 14.

At block 407, the flat sheet 14 is bent to form a curve sheet 15, the curve sheet 15 includes the bent portion 110, and a curvature of the curve sheet 15 corresponds to the housing 100.

At block 409, a positioning opening 151 is defined on the curve sheet 15 to receive electronic components of the mobile phone, such as a camera, a Light-Emitting Diode(LED), or a speaker.

At block 411, adhesives are coated on the bent portion 110 of the curve sheet 15 to form the connecting layer 30. It is understood that, the connecting layer 30 can also be coated on other areas of the curve sheet 15 as desired.

At block 413, the curve sheet 15 is put into a mould (not show), thus the positioning opening 151 is fixed on a positioning structure of the mould, thereby fixing the curve sheet 15. The positioning portion 41 is formed on an area of the curve sheet 15 corresponding to the connecting layer 30 by the injection molding process; the positioning portion 41 can also be coated on other areas of the curve sheet 15 as desired.

It is understood that, the block 411 can be incorporated into the block 405. So the block 403 is that the printing layer 20 is printed the second surface 112 of the base layer 11 according to the shape of the housing 100. In at least one embodiment, the printing layer 20 includes a plurality of printing areas 21 arranged on the composite panel 10. A shape of each printing area 21 corresponds to the shape of the housing 100, and an adhesive is coat on the edge of the printing area 21 for forming the connecting layer 30.

It is understood that, the block 409 can be incorporated into the block 405. So the block 405 is that the printing area 21 is cut from the composite panel 10 by a cutting equipment to form a plurality of flat sheet 14. The flat sheet 14 defines a positioning opening 151.

In summary, the composite panel 10 is combined with the injection layer 40 to manufacture the housing 100, thus, the thickness of the composite panel 10 is thinner, and a thickness of the housing 100 can be significantly reduced. In addition, the film 13 of the composite panel 10 is a hard film to protect the pattern of the printing layer 20 from scratching. The process of the manufacture the housing 100 is easy, and the housing 100 is light weight and have a kind of appearances.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A housing comprising:
a composite panel comprising a base layer, a cementing layer, and a film; wherein the film is integrally formed on the base layer by the cementing layer;
a printing layer disposed on the base layer opposite to the film; and
an injection layer disposed on the printing layer.

2. The housing of claim 1, further comprising a connecting layer printed on the printing layer, wherein the injection layer is injected on the connecting layer.

3. The housing of claim 1, wherein the base layer comprises a first surface and a second surface opposite to the first surface, the cementing layer is disposed on the first surface, and the printing layer is disposed on the second surface.

4. The housing of claim 1, wherein the film is a hardness film.

5. The housing of claim 1, wherein the housing is bent toward a center of the housing and forms a bent portion, the injection layer comprises a positioning portion, the positioning portion is disposed on the bent portion.

6. The housing of claim 5, wherein a positioning opening is defined on the housing to receive electronic components.

7. The housing of claim 1, wherein a thickness of housing is 0.4 mm-0.7 mm.

8. A manufacturing method of a housing comprising;
forming a film on a base layer by a cementing layer to form a composite panel;
printing a plurality of printing areas are on the composite panel;
cutting the each printing area from the composite panel to form a flat sheet;
bending the flat sheet to form a curve sheet; and
putting the curve sheet into a mould, wherein a injection layer is formed on the printing area by the injection molding to form the housing.

9. The manufacturing method of claim 8, further comprising defining a positioning opening on the curve sheet.

10. The manufacturing method of claim 8, further comprising defining a positioning opening on the flat sheet.

11. The manufacturing method of claim 8, further comprising coating a connecting layer on the curve sheet.

12. The manufacturing method of claim 8, further comprising coating a connecting layer on the printing area.

13. A housing comprising:
a printing layer; and
a composite panel; the composite panel comprising a base layer, a cementing layer, and a film;
wherein the film is integrally formed on the base layer by the cementing layer; the printing layer is disposed on the base layer opposite to the film.

14. The housing of claim 13, further comprising an injection layer, wherein a connecting layer is printed on the printing layer, the injection layer is injected on the connecting layer.

15. The housing of claim 13, wherein the base layer comprises a first surface and a second surface opposite to the first surface, the cementing layer is disposed on the first surface, and the printing layer is disposed on the second surface.

16. The housing of claim 13, wherein the film is a hardness film.

17. The housing of claim 13, wherein the housing is bend toward a center of the housing and forms a bent portion, the injection layer comprises a positioning portion, the positioning portion is disposed on the bent portion.

18. The housing of claim 15, wherein a positioning opening is defined on the housing to receive electronic components.

19. The housing of claim 13, wherein a thickness of housing is 0.4 mm-0.7 mm.
